(19) United States
(12) Patent Application Publication
(10) Pub. No.: US 2008/0218476 A1
(43) Pub. Date: Sep. 11, 2008

(54) Apparatus and method for wrist supporting movement translator and mouse button device

(76) Inventor: Bharat (Bobby) Patel, Boynton Beach, FL (US)

Correspondence Address: OSHA LIANG L.L.P., 1221 MCKINNEY STREET, SUITE 2800, HOUSTON, TX, 77010, US

(21) Appl. No.: 11/715,758

(22) Filed: Mar. 8, 2007

(51) Int. Cl. G06F 3/033

(52) U.S. Cl. 345/163

(57) ABSTRACT

A movement translator configured to be worn on a wrist for transmitting movement information relative to an external surface. The movement translator may include an enclosure. The enclosure may include an arcuate wrist supportive concave surface having a shallow wrist-rest and an enclosure side. An adjustable strap may cooperate with the enclosure side to form a wrist band adjacent to the shallow wrist-rest. A movement detector is within the enclosure for operatively coupling the external surface. In addition, a wireless transmitter is coupled to the movement detector for transmitting an encoded signal, wherein the encoded signal encodes a magnitude of a movement estimated between the movement detector and the external surface during a period of time.

### BACKGROUND OF INVENTION

Pointing devices are used by people to control operation of computers or data processing systems. Generally, such pointing devices permit a user to identify a portion of a computer display representative of a function or data that the user wishes to execute or manipulate. A user may, for example, use a mouse as a pointing device, in coordination with a controllable cursor, to select a menu or highlight text, among other things.

In some fields, a user may continuously use a pointing device, for example, a mouse. A common form of a mouse includes a housing that detects the relative movement of the mouse relative to a surface underneath the mouse and transmits signals of such movement to a host computer. In addition, such a mouse provides one or more buttons by which a user may perform a selection or other operation in relation to a current position of a cursor. Unfortunately, the typical mouse provides support only for the hand, leaving the user potentially to operate the mouse with a wrist cocked at an awkward angle. In addition, the typical mouse uses electromechanical switches that require a finger pressure and wrist flexure in order to close or otherwise change the state of one or more switches. Repeated pressing of such switches can lead to unwanted strains on a user's wrist and tendons supporting the wrist and the hand.

### SUMMARY OF INVENTION

In general, in one aspect, the invention relates to a movement translator configured to be worn on a wrist for transmitting movement information relative to an external surface. The movement translator may include an enclosure. The enclosure may include an arcuate wrist supportive concave surface having a shallow wrist-rest and an enclosure side. An adjustable strap may cooperate with the enclosure side to form a wrist band adjacent to the shallow wrist-rest. A movement detector is within the enclosure for operatively coupling the external surface. In addition, a wireless transmitter is coupled to the movement detector for transmitting an encoded signal, wherein the encoded signal encodes a magnitude of a movement estimated between the movement detector and the external surface during a period of time.

In one or more embodiments the invention relates to a mouse button device for generating a mouse button signal to a computer system associated with a movement translator. The mouse button device may include a touchpad having a first planar surface associated with a first mouse button function, the first planar surface located separate from a keyboard associated with the computer system, and the first planar surface physically detached from the movement translator. The touch pad may also have and a second planar surface associated with a second mouse button function, the second planar surface located separate from the keyboard associated with the computer system, and the second planar surface physically detached from the movement translator. If a finger touches the first planar surface, the mouse button device transmits a first mouse button function signal to the computer system. If a finger touches the second planar surface, the mouse button device transmits a second mouse button function signal to the computer system.

Other aspects and alternative useful embodiments of the invention will be apparent from the following description and the appended claims.

### BRIEF DESCRIPTION OF DRAWINGS

FIG. 1 shows a prior art computer system.

FIG. 2 shows the computer system with an additional pointer device in accordance with one or more embodiments of the invention.

FIG. 3 shows a user arrangement of a movement translator in relation to a user's hand and other devices in accordance with one or more embodiments of the invention.

FIGS. 4A-4C show various views of a movement translator in accordance with one or more embodiments of the invention.

FIG. 5 shows a mouse button device for generating a mouse button signal to a computer system in accordance with one or more embodiments of the invention.

FIG. 6 shows an alternative embodiment of a mouse button device.

FIG. 7 shows a sequence of steps that a device driver may execute within the computer system, in accordance with one or more embodiments of the invention.

### DETAILED DESCRIPTION

One or more embodiments of the invention will be described with reference to the accompanying figures. Like items in the figures are shown with the same reference numbers.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

Embodiments of the invention relate to methods and apparatus for supporting a wrist while operating a pointing device. More specifically, one or more embodiments of the invention may permit a user to use little or no force activating a mouse button function.

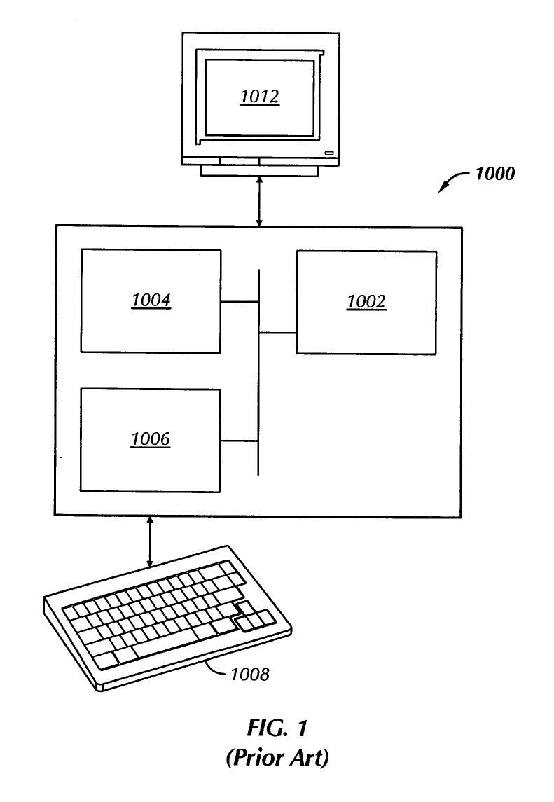

FIG. 1 shows a prior art computer system. The present invention may be implemented on many types of computer system, regardless of the platform being used. The computer system 1000 includes a processor 1002, associated memory 1004, a storage device 1006, and numerous other elements and functionalities typical of a computer (not shown). The computer system 1000 may also include input device or means, such as a keyboard 1008, and output device or means, such as a monitor 1012. The computer system 1000 may be connected to a local area network (LAN) or a wide area network (e.g., the Internet) (not shown) via a network interface connection (not shown). Those skilled in the art will appreciate that these input and output means may take other forms.

Further, one or more elements of the computer system 1000 may be integrated into a single housing and form, for example, a personal digital assistant. Further, software instructions to perform embodiments of the invention may be stored on a computer readable medium such as a compact disc (CD), a diskette, a tape, a file, or any other computer readable storage device.

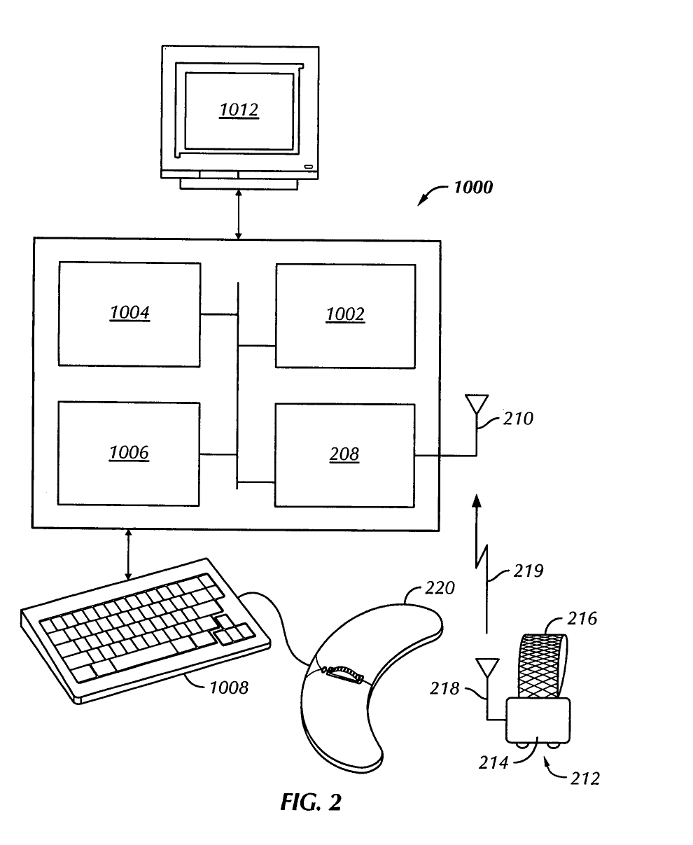

FIG. 2 shows the computer system 1000 of FIG. 1 with an additional pointer device in accordance with one or more embodiments of the invention. A movement translator 212 may, for example, be considered as a device capable of converting two dimensional movements to an encoded signal. The two dimensional movements are measured or estimated in relation to the position of the movement translator relative to an external surface. A movement detector measures the movements. A movement detector in one or more embodiments includes a device that measures movement along at least one axis. The encoded signal is a signal that carries at least one magnitude of a movement estimated between the movement detector and the external surface. An additional magnitude and direction or directions may also be carried or encoded by the encoded signal. An optical sensor may operate to estimate the magnitude of the movement as well as determine the direction of the movement.

The movement translator 212 may include a wireless transmitter that transmits the encoded signal via an antenna 218. The wireless transmitter is a device that transmits signals wirelessly. The wireless transmitter may be, for example, a radio transceiver such as a Bluetooth standard transceiver. In addition, the wireless transmitter may operate using infrared radiation, light waves, other electromagnetic signals, or sound.

The movement translator 212, described above, provides an adjustable strap 216. A user may attach the movement translator 212 to the user's wrist using the adjustable strap 216. The adjustable strap may include a flexible material that may be adjusted to form a loop suitable for typical human wrist sizes. When adjusted to form a loop, the adjustable strap 216 forms a wrist band. Parts of an enclosure 214 may also form the wrist band.

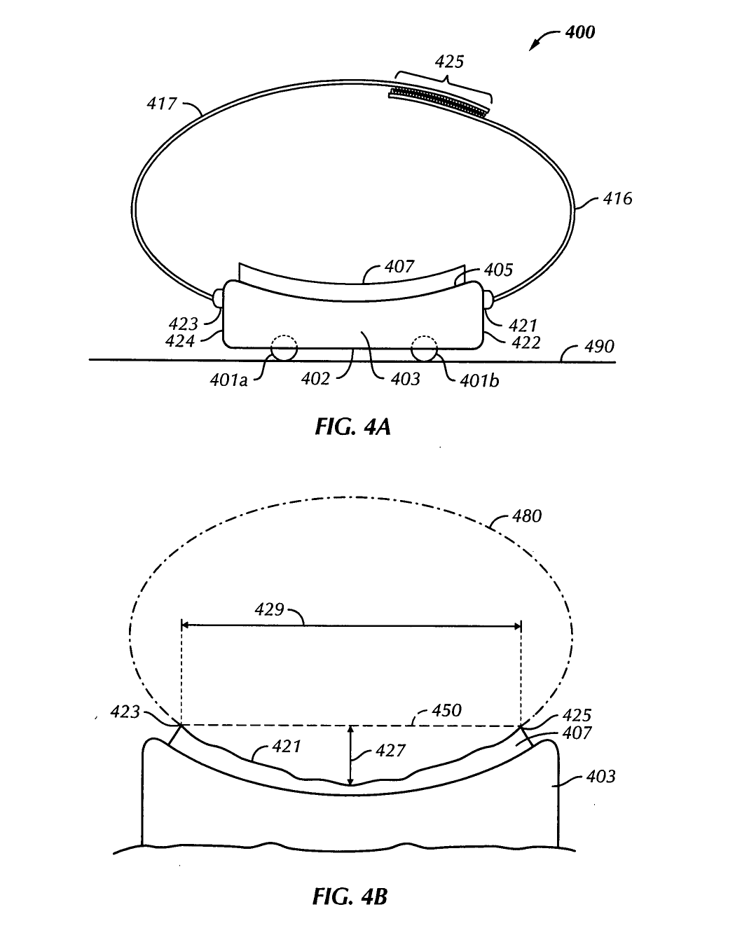

The enclosure 214 provides a structure that supports various aspects of a wireless transmitter. For example, the enclosure may support an antenna, shown, for example, as antenna 218. Additional devices and components of the movement translator will be described further in reference to FIGS. 4A, 4B, and 4C.

Continuing with FIG. 2, a computer system 1000 has an additional wireless receiver 208 that receives ambient wireless signals through, for example, a receiving antenna 210. The wireless receiver 208 operates to decode signals that carry a magnitude of a movement estimated between the movement detector and the external surface. When decoding, the wireless receiver 208 forms a movement signal 219. The wireless receiver 208 may present the movement signal as a number within a scale of numbers. A movement signal below a certain number may represent a movement in a direction, while a movement signal above a certain number may represent a movement in an opposite direction relative to the movement translator. For example, a number representing a left movement of the movement translator may be digitally encoded as a −5. In contrast, a right movement of the movement translator may be digitally encoded as a +5. A pair of signals may be sent together to represent a combination of vectors along orthogonal axes. Such axes may include a left-right axis and a forward-backward axis, wherein such terms as ‘left’ and ‘forward’ are in relation to the correct or typical attachment of the movement translator to a human wrist in relation to the wearer's point of view.

Complementing the movement translator 212 is a touchpad 220. A touchpad 220 is a device that converts a human touch into a mouse button function signal. The touchpad transmits the mouse button function signal, for example, by delivering an electrical signal over a cable assembly to the keyboard and indirectly to the computer system 1000. It is appreciated that the touchpad may alternatively be configured to transmit a mouse button function signal to the computer system 1000 using a wireless channel. As can be seen, the touchpad 220 is located separate from the computer system 1000 and keyboard 1008.

Thus, the disclosed devices permit a user to wear a movement translator to move a cursor and provide inputs to a computer system along two dimensions in a plane. The user benefits from having support for a wrist and may exert low force to contact a touchpad. The touchpad operates in cooperation with the movement translator to provide a signal to the computer system that the user has selected a mouse button function. The combined effect of the cooperating devices may be to reduce strains on a user's hand as well as provide comfortable heat retention in an adjustable strap. In addition, the movement translator may permit unfettered operation of a keyboard and also support a wrist when a user intends to move a cursor or provide other directional control.

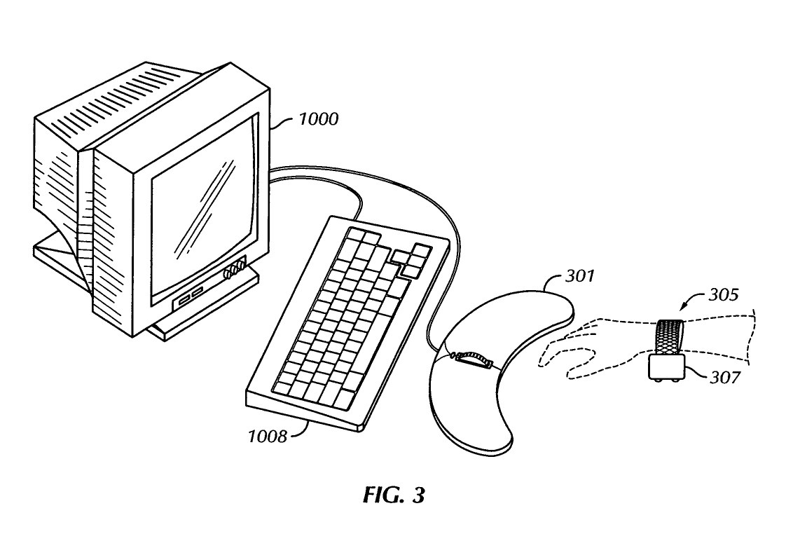

FIG. 3 shows a user arrangement of the movement translator in relation to a user's hand and other devices in accordance with one or more embodiments of the invention. A computer system 1000 receives inputs from a keyboard 1008. A mouse button device 301 may be placed on an external surface between a user's seated position and the keyboard 1008. A user wears the movement translator 305 on, for example, a right hand. While the hand is in a prostrate position, the enclosure 307 of the movement translator is worn below the wrist between the palm and elbow advantageously positioned to interact with horizontal external surfaces below the wrist. The FIG. 3 embodiment of the mouse button device 301 may connect to the computer system 1000 through a cable assembly, attaching to a serial bus, for example, a Universal Serial Bus (USB) interface. The movement translator may rely upon contact points to slide with ease. The contact points may be made of a slippery material in the form of a low friction pad.

FIG. 4A shows a side view of the movement translator as may be seen looking longitudinally along an arm of a wearer of the movement translator in accordance with one or more embodiments of the invention. The movement translator 400 may rest upon, and measure movement relative to, an external surface 490. The movement translator 400 may slide or otherwise move while supported by reduced friction contact points. Reduced friction contact points are surfaces that provide a gliding surface to permit easy lateral movement of the movement translator. Reduced friction contact points may be, for example, low friction horizontal pads, rollerballs 401a, 401b, or any other mechanism to assist a stable horizontal movement. The rollerballs 401a, 401b, protrude through a lower surface of the enclosure 402.

The enclosure 403 may be supported by an adjustable strap 416. The adjustable strap is a flexible strap for encircling a wrist. The adjustable strap attaches at a first strap connector 421. The adjustable strap 416 may cooperate with a second strap connector 423 by attaching to an attachment strap 417. The adjustable strap 416 and the attachment strap 417 may connect to form a loop with a fastener 425. The fastener 425 may be, for example, a fabric fastener such as a hook and loop material, for example, Velcro® (Velcro is a trademark of Velcro Industries B.V.). Alternatively, the fastener 425 may be a buckle or other detachable strap connecting device. It is appreciated that many other types of fasteners may operate to connect the adjustable strap 416 and the attachment strap 417. The first strap connector 421 may extend from a first enclosure side 422. The first enclosure side 422 may be facing to a right side when a user wears the movement translator and holds the user's arm straight with the palm down. In other words, the first enclosure side is a side from which a strap may attach or otherwise extend. The second strap connector 423 may extend from a second enclosure side 424.

The enclosure 403 is supported by, at least in one embodiment, rollerballs 401a and 401b. The enclosure 403 is a housing that encloses a space and permits signals and power to be exchanged with the environment. For example, the enclosure may provide an opening through which relative movement of the movement translator may be determined, for example, a rollerball coupled to rotary encoders or an optical sensor. An enclosure may be substantially made of plastic, metal, or any other suitable material.

The top of the enclosure 403 may be formed as an arcuate wrist supportive concave surface 405. The arcuate wrist supportive concave surface 405 provides a generally concave surface disposed upward towards, for example, a wrist. The arcuate wrist supportive concave surface 405 may be positioned under the radius and ulna bones and generally support such anatomy below such features.

A shallow wrist-rest 407 is attached to the enclosure and disposed above the arcuate wrist supportive concave surface 405. The shallow wrist-rest 407 may be attached to the enclosure 403 with snaps, straps, buttons, adhesive, and the like. The shallow wrist-rest 407 is a flexible material that conforms to some contours of the human wrist when correctly worn as described in relation to FIG. 3. The shallow wrist-rest 407 may be, for example, a heat retaining and skin ventilating material. The shallow wrist-rest 407 may be made out of Thermoskin®, a registered trademark of Volcano International Medical AB Corporation. To facilitate comfort and ease of attachment in one or more embodiments the shallow wrist-rest is not U-shaped.

FIG. 4B shows a cross-sectional view of a shallow wrist-rest when in contact with a typical human wrist in accordance with one or more embodiments of the invention. For the sake of clarity, the straps and lower features of the enclosure are not shown. As explained earlier, the enclosure 403 supports the shallow wrist-rest 407. The shallow wrist wrest 407 has an upper surface 421. FIG. 4B shows the upper surface 421 in substantial contact with a human wrist 480. The upper surface is deformable to match contours of a human wrist. The upper surface 421 is that surface disposed to contact a wrist when the movement translator is worn. The upper surface has two cusps 423, 425. Each cusp is an edge of the shallow wrist-rest that includes a highest point of a cross-section of the shallow wrist rest 407.

Each cross-section of the shallow wrist-wrest 407 may have a line 450 between the first cusp and the second cusp. The line 450 between the first cusp and the second cusp is not physically present. Rather, the line 450 between the first cusp and the second cusp is a reference line. Each curve has a maximum deflection 427. The maximum deflection 427 is a distance between the curve and the reference line such that no other end-point on a curve has a greater distance to the reference line. The upper surface may have a maximum deflection along a cross section that is less than one third a distance 429 between the first cusp and the second cusp.

FIG. 4C shows a bottom view of the movement translator 400 in accordance with one or more embodiments of the present invention. An opening in the enclosure 403 for an optical sensor 451 allows a detection of movement along two axes. Multiple rollerballs 453, 454, 455, 456 operate to reduce friction between the movement translator and the external surface. A power button 457 may operate to allow a user to select a power setting from a group consisting of power on and power off. In addition, the movement translator 400 may have electrical contacts 459 for recharging a power source. A power source may be a rechargeable battery. The power source may provide electrical power to a wireless transmitter and to a movement detector housed within the enclosure.

The enclosure has several dimensions or distances between extremities of the enclosure. The enclosure has a distance between a first strap connector and the second strap connector 463. The enclosure has an enclosure front-to-back distance 465. The distance between the first strap connector and the second strap connector 463 may be greater than the enclosure front-to-back distance 465.

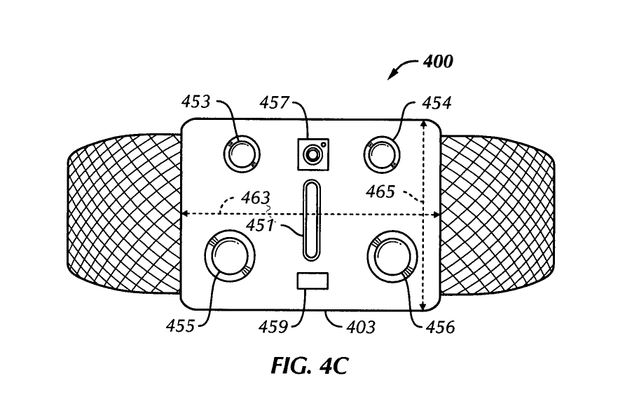

FIG. 5 shows a mouse button device for generating a mouse button signal to a computer system in accordance with one or more embodiments of the invention. The mouse button device may comprise a touchpad. The mouse button device may be of a thickness consistent with a keyboard lip, for example, the lip of the keyboard between a user and the ‘space’ key. Consequently, the mouse button device may be less than one inch thick.

The touchpad 501 may be divided into a first planar surface 503 associated with a first mouse button function, and a second planar surface 505 associated with a second mouse button function. The first mouse button function may be associated with button functions traditionally appearing on a left side of a conventional mouse. Each of the first planar surface 503 and the second planar surface 505 may be located separate from a keyboard 550 of the computer system 560. Nevertheless, the touchpad 501 may be attached to the computer system 560 via a cable assembly 511. In at least one embodiment of the invention, the cable assembly interconnects to a connector of the computer system 560. As stated earlier, the connector may be a serial bus according to the Universal Serial Bus (USB) standard. As may be appreciated, the touchpad 501 may alternatively communicate with the computer system 560 using a wireless interface or transceiver.

The touch pad 501 may include a scroll button 515 centrally to the touch pad. The scroll button 515 may operate like a conventional scroll button, permitting a user to slide the scroll button toward the user and away from the user. In addition the scroll button may allow the user to press down on the scroll button 515 to achieve a contact switch closure and corresponding signal. Scroll button 515 may be implemented as a track pad. A track pad in one or more embodiments includes a user interface formed from a capacitive sensor array.

In at least one embodiment of the mouse button device, the mouse button device includes a wireless receiver for receiving a signal based on a magnitude of movement estimated at the movement translator. Thus, the cable assembly 511 may be configured to relay or otherwise transmit a signal based on the magnitude of the movement estimated at the movement translator.

Operation of the planar surfaces may be by operation of a touch switch. A touch switch relies on sensing a change in capacitance on a conductive plate. The plate may occupy the planar surface. When a user touches the conductive plate, a circuit of the touch switch registers the change of capacitance and signals a mouse button function to the computer system.

Alternatively, operation of the planar surface may be by operation of an electromechanical switch. The electromechanical switch receives a downward force and allows the planar surface to be displaced downward, thus bringing two conductors into or out of a complete electrical circuit. The electromechanical switch state change is accordingly reported to the computer system as a mouse button function signal. In this embodiment, the planar surface forms a top to an electromechanical switch.

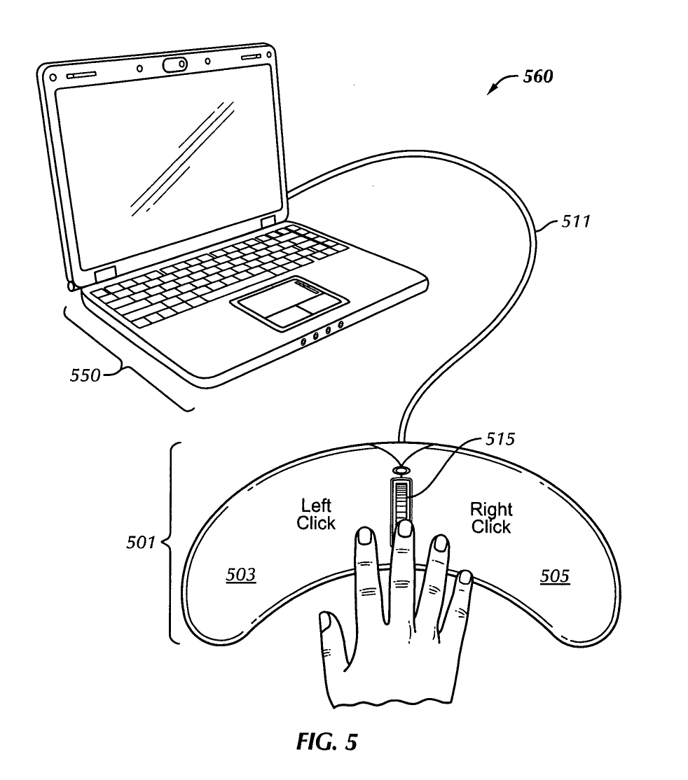

FIG. 6 shows an alternative embodiment of a mouse button device. Mouse button device 600 may have a first left mouse button function planar surface 601 and a second left mouse button function planar surface 603. In addition, mouse button device 600 may have a first right mouse button function planar surface 605 interposed between first left mouse button function planar surface 601 and second left mouse button function planar surface 603. The first right mouse button function planar surface 605 may be supplemented by second right mouse button function planar surface 607. In the configuration of FIG. 6, the mouse button device 600 transmits a first mouse button function signal if either of the left mouse button function planar surfaces 601, 603 are activated. Similarly, the mouse button device 600 transmits a second mouse button function signal if either of the right mouse button function planar surfaces 605, 607 are activated.

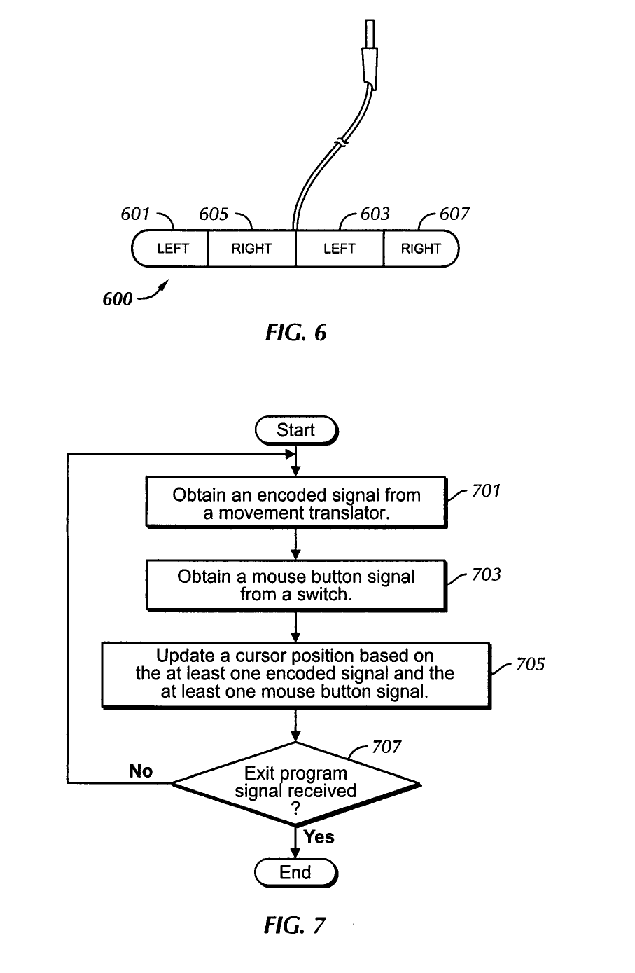

FIG. 7 shows a sequence of steps that a device driver may execute within the computer system 1000 of FIG. 2, in accordance with one or more embodiments of the invention. Initially, the device driver obtains at least one encoded signal from a movement translator (step 701). The device driver may receive the encoded signal during an appropriate period of time. A period of time may be on the order of tenths of a second or any sufficiently small period such that strokes of the movement translator appear smooth when expressed as movement of a cursor. The movement translator may be, for example, movement translator 400 of FIG. 4A.

Next, the device driver obtains a mouse button signal from a switch (step 703). The switch is a switch of a mouse button device, for example, mouse button device 501 of FIG. 5. The switch may not be connected to the movement translator. The user may, according to user preference, pre-program an operating system or an application to assign a user-selected function to a mouse button signal. Next, the device driver updates a cursor position based on the at least one encoded signal and the at least one mouse button signal (step 705). A cursor position is a location in at least one display where a cursor is displayed. The cursor position may include stored information concerning a cursor's absolute position within a display or the relative position the cursor may occupy within a window. Finally, the device driver determines whether an exit program signal has been received (step 707). If no exit program signal has been received, the device driver re-executes step 701 above. Otherwise, the device driver terminates processing.

Thus, embodiments of the invention have been shown that permit a user to wear a movement translation device and receive support to a wrist. In addition, embodiments of the invention may allow little or no downward force to trigger a mouse button function signal. Desktop and portable computers may be amenable to operating with the touch pad and the translator mouse

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A movement translator configured to be worn on a wrist for transmitting movement information relative to an external surface, the movement translator comprising:
an enclosure comprising:
an arcuate wrist supportive concave surface having a shallow wrist-rest;
an enclosure side;
at least one adjustable strap operable to cooperate with the enclosure side to form a wrist band adjacent to the shallow wrist-rest;
a movement detector disposed within the enclosure for operatively coupling the external surface; and
a wireless transmitter coupled to the movement detector for transmitting an encoded signal, wherein the encoded signal encodes a magnitude of a movement estimated between the movement detector and the external surface during a period of time.

2. The movement translator of claim 1, wherein the shallow wrist-rest comprises an upper surface comprising:
a first cusp;
a second cusp; and
a curve that has a maximum deflection from a line between the first cusp and the second cusp, wherein the maximum deflection is less than one third a distance between the first cusp and the second cusp; and the enclosure further comprises:
a first strap connector, and a second strap connector, wherein the at least one adjustable strap attaches to the first strap connector, and the enclosure side has a second strap connector for user-selectable attachment and detachment of the at least one adjustable strap.

3. The movement translator of claim 1, wherein the shallow wrist-rest is not U-shaped and the encoded signal encodes at least one direction.

4. The movement translator of claim 1, further comprising at least two reduced friction contact points.

5. The movement translator of claim 4, wherein the at least two reduced friction contact points comprise at least three rollerballs disposed to protrude through a lower surface of the enclosure, wherein the at least three rollerballs are operable to support the enclosure on the external surface.

6. The movement translator of claim 1, wherein the arcuate wrist supportive concave surface comprises a heat retaining and skin ventilating material deformable to match contours of a human wrist.

7. The movement translator of claim 6, wherein the arcuate wrist supportive concave surface is adapted to conform to a wrist and to resist wrist flexure so that adverse effects of carnal tunnel syndrome from repeated wrist flexure are reduced.

8. The movement translator of claim 7, wherein the arcuate wrist supportive concave surface is moisture ventilating.

9. The movement translator of claim 2, wherein the adjustable strap is operable to cooperate with the second strap connector through an attachment strap having a fabric fastener.

10. The movement translator of claim 2, wherein the adjustable strap is operable to cooperate with the second strap connector through an attachment strap having a buckle.

11. The movement translator of claim 2, wherein the enclosure has a distance between the first strap connector and the second strap connector greater than an enclosure front-to-back distance.

12. The movement translator of claim 11, further comprising at least three rollerballs disposed to protrude through a lower surface of the enclosure, wherein the at least three rollerballs are operable to support the enclosure on the external surface; wherein the arcuate wrist supportive concave surface comprises a heat retaining and skin ventilating material: and wherein the adjustable strap is operable to cooperate with the second strap connector though an attachment strap having a fabric fastener.

13. The movement translator of claim 11, wherein the arcuate wrist supportive concave surface comprises a heat retaining and skin ventilating material.

14. The movement translator of claim 11, wherein the adjustable strap is operable to cooperate with the second strap connector though an attachment strap having a fabric fastener.

15. The movement translator of claim 1, further comprising:
a power source for driving the wireless transmitter and the movement detector, the power source disposed substantially within the enclosure; and
a power button for selecting a power setting is at least one selected from a group consisting of power on and power off.

16. The movement translator of claim 15, wherein the adjustable strap is operable to cooperate with the second strap connector through an attachment strap having a fabric fastener.

17. The movement translator of claim 15, further comprising at least three rollerballs disposed to protrude through a lower surface of the enclosure, wherein the at least three rollerballs are operable to support the enclosure on the external surface.

18. A mouse button device for generating a mouse button signal to a computer system associated with a movement translator comprising:
a touchpad comprising:
a first planar surface associated with a first mouse button function, the first planar surface located separate from a keyboard associated with the computer system, and the first planar surface physically detached from the movement translator; and
a second planar surface associated with a second mouse button function, the second planar surface located separate from the keyboard associated with the computer system and the second planar surface physically detached from the movement translator,
wherein the first planar surface, responsive to a first finger touch, transmits a first mouse button function signal to the computer system; and the second planar surface, responsive to a second finger touch, transmits a second mouse button function signal to the computer system.

19. The mouse button device of claim 18, wherein the first planar surface comprises a plate on a first touch switch and the second planar device comprises a plate on a second touch switch.

20. The mouse button device of claim 19, wherein a scroll button is disposed between the first planar surface and the second planar surface.

21. The mouse button device of claim 18, wherein the touchpad is less than one inch high.

22. The mouse button device of claim 21, wherein the first planar surface is a top to a first electromechanical switch and the second planar surface is a top to a second electromechanical switch.

23. The mouse button device of claim 22, wherein the touchpad further comprises a cable assembly for interconnection to a connector of the computer system and is configured to transmit the first mouse button function signal and the second mouse button function signal to the computer system.

24. The mouse button device of claim 23, wherein the touchpad further comprises a wireless receiver for receiving a signal based on a magnitude of a movement estimated at the movement translator and the cable assembly is further configured to transmit a signal based on the magnitude of the movement estimated at the movement translator.

25. The mouse button device of claim 19, further comprising:
a third planar surface associated with the first mouse button function, the third planar surface physically detached from the keyboard associated with the computer system and the third planar surface located separate from the movement translator; and
a fourth planar surface associated with the second the second mouse button function, the fourth planar surface physically detached from the keyboard associated with the computer system and the fourth planar surface located separate from the movement translator.

26. A program storage device readable by a machine tangibly embodying a program of instructions executable by the machine to perform method steps for displaying a cursor to a display, said method steps comprising:
(a) obtaining at least one encoded signal from a movement translator;
(b) obtaining at least one mouse button signal from a switch; and
(c) updating a cursor position based on the at least one encoded signal and the at least one mouse button signal.

27. The program storage device of claim 26, wherein the switch is a mouse button device.

28. The program storage device of claim 26, wherein the at least one encoded signal is a wireless signal.

29. The program storage device of claim 26, wherein the at least one mouse button signal arrives on a serial bus.
